(19) United States
(12) Patent Application Publication
(10) Pub. No.: US 2006/0242016 A1
(43) Pub. Date: Oct. 26, 2006

(54) Dynamic advertisement system and method

(75) Inventor: Jesse Chenard, Norwalk, CT (US)

Correspondence Address: GROSSMAN, TUCKER, PERREAULT & PFLEGER, PLLC, 55 SOUTH COMMERICAL STREET, MANCHESTER, NH, 03101, US

(73) Assignee: Tremor Media LLC, New York, NY (US)

(21) Appl. No.: 11/331,684

(22) Filed: Jan. 13, 2006

Related U.S. Application Data
(60) Provisional application No. 60/643,883, filed on Jan. 14, 2005.

(51) Int. Cl. G06Q 30/00

(52) U.S. Cl. 705/14

(57) ABSTRACT

A dynamic advertisement method, system and computer program product for receiving a request for a content file from a user. An ad insertion file associated with the content file is processed, such that the ad insertion file associates one or more advertisements with the content file. The insertion of the one or more advertisements into the content file is facilitated.

### RELATED APPLICATIONS

This application claims the priority of the following application, which is herein incorporated by reference: U.S. Provisional Application Ser. No. 60/643,883, filed 14 Jan. 2005, entitled, “DYNAMIC ADVERTISING SYSTEM AND METHOD”.

### TECHNICAL FIELD

This disclosure relates to advertisement systems and, more particularly, to dynamic advertisement systems.

### BACKGROUND

The manner in which people get information is rapidly changing. Traditionally, information (such as general news) was received from newspapers, magazines, and nightly news broadcasts, for example. However, with technical innovations such as the internet and the popularity of high-speed internet connections, people may now retrieve the desired information from internet websites. Often, this information is in the form of streaming video, and may include news videos, sports videos, and general entertainment videos, for example.

Unfortunately, the infrastructure expenses associated with streaming video can be quite substantial and the websites that provide this video information must recover these expenses in order to continue to provide such services. While some websites charge monthly memberships fees to subscribers, other websites embed advertisements within the video streams to defray the costs of streaming the video(s). Accordingly, an advertisement is typically attached to the video in question. For example, if the video is a news clip concerning a plane crash, a first advertisement may be attached to the beginning of the video, and a second advertisement may be attached to the end of the video. Further, additional advertisements may be interspersed throughout the video.

### SUMMARY OF THE DISCLOSURE

In one implementation, a dynamic advertisement method includes receiving a request for a content file from a user. An ad insertion file associated with the content file is processed, such that the ad insertion file associates one or more advertisements with the content file. The insertion of the one or more advertisements into the content file is facilitated.

One or more of the following features may also be included. The content file may be a video data stream. Facilitating the insertion of the one or more advertisements may include obtaining the one or more advertisements from a remote server. Facilitating the insertion of the one or more advertisements may include requesting the one or more advertisements from a remote server. Facilitating the insertion of the one or more advertisements may include inserting the one or more advertisements into the content file.

The dynamic advertisement method may include verifying that the user has a content viewer installed that is capable of viewing the content file, and installing the content viewer if it is determined that the content viewer is not installed. The ad insertion file may be associated with multiple content files. The content file and/or the one or more advertisements may be transmitted to the user.

A system may be configured to implement the above-described method.

In another implementation, a computer program product residing on a computer readable medium has a plurality of instructions stored on it. When executed by the processor, the instructions cause the processor to perform operations including receiving a request for a content file from a user. An ad insertion file associated with the content file is processed, such that the ad insertion file associates one or more advertisements with the content file. The insertion of the one or more advertisements into the content file is facilitated.

One or more of the following features may also be included. The content file may be a video data stream. Facilitating the insertion of the one or more advertisements may include obtaining the one or more advertisements from a remote server. Facilitating the insertion of the one or more advertisements may include requesting the one or more advertisements from a remote server. Facilitating the insertion of the one or more advertisements may include inserting the one or more advertisements into the content file.

The dynamic advertisement method may include verifying that the user has a content viewer installed that is capable of viewing the content file, and installing the content viewer if it is determined that the content viewer is not installed. The ad insertion file may be associated with multiple content files. The content file and/or the one or more advertisements may be transmitted to the user.

The details of one or more implementations is set forth in the accompanying drawings and the description below. Other features and advantages will become apparent from the description, the drawings, and the claims.

### BRIEF DESCRIPTION OF THE DRAWINGS

FIG. 1 is a diagrammatic view of a dynamic advertisement system coupled to a distributed computing network; and

FIG. 2 is a flow chart of a process executed by the dynamic advertisement system of FIG. 1.

Although the following Detailed Description will proceed with reference being made to illustrative embodiments, many alternatives, modifications, and variations thereof will be apparent to those skilled in the art. Accordingly, it is intended that the claimed subject matter be viewed broadly, and be defined only as set forth in the accompanying claims

### DETAILED DESCRIPTION OF THE PREFERRED EMBODIMENTS

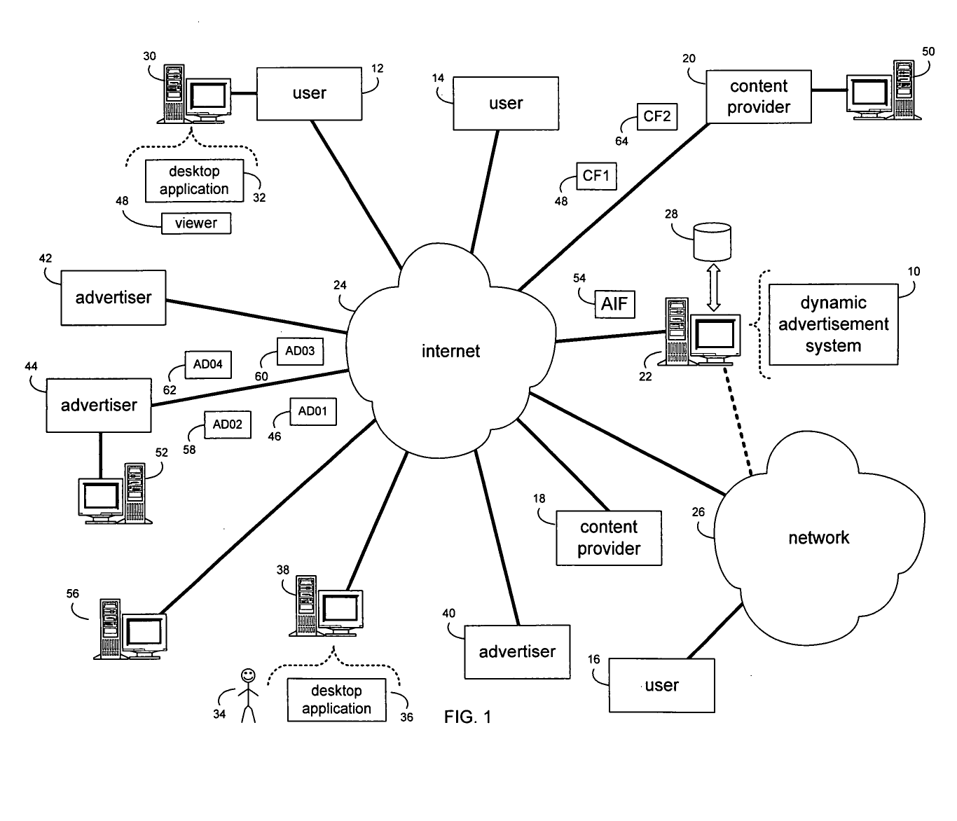

Referring to FIG. 1, there is shown a dynamic advertisement system 10 that allows users (e.g., users 12, 14, 16) to select and view content files (e.g., a video data stream) provided by content providers (e.g., content providers 18, 20). When viewed by a user, one or more advertisements may be inserted into the content file in accordance with an ad insertion file (to be discussed below in greater detail).

Dynamic advertisement system 10 may reside on and may be executed by a computer 22 that is connected to network 24 (e.g., the internet). Computer 22 may be a web server running a network operating system, such as Microsoft Windows XP Server™, Novell Netware™, or Redhat Linux™. Computer 22 may also execute a web server application, such as Microsoft IIS™, Novell Webserver™, or Apache Webserver™, that allows for HTTP (i.e., HyperText Transfer Protocol) access to computer 22 via network 24. Network 24 may be connected to one or more secondary networks (e.g., network 26), such as: a local area network; a wide area network; or an intranet, for example.

The instruction sets and subroutines of dynamic advertisement system 10, which may be stored on a storage device 28 coupled to computer 22, may be executed by one or more processors (not shown) and one or more memory architectures (not shown) incorporated into computer 22. Storage device 28 may be, for example, a hard disk drive, a tape drive, an optical drive, a RAID array, a random access memory (RAM), or a read-only memory (ROM).

Users 12, 14, 16 may access dynamic advertisement system 10 and the content provided by content providers 18, 20 directly through network 24 or through secondary network (e.g., network 26). Further, computer 22 (i.e., the computer that executes dynamic advertisement system 10) may be connected to network 24 through a secondary network (e.g., network 26).

Users 12, 14, 16 may access dynamic advertisement system 10 and the content provided by content providers 18, 20 through a computer (e.g., computer 30) that is connected to network 24 (or network 26) and executes a desktop application 32 (e.g., Microsoft Internet Explorer™, Netscape Navigator™, or a specialized interface).

An administrator 34 typically accesses and administers dynamic advertisement system 10 through a desktop application 36 (e.g., Microsoft Internet Explorer™, Netscape Navigator™, or a specialized interface) running on an administrative computer 38 that is also connected to the network 24 (or network 26).

As stated above, dynamic advertisement system 10 may allow users (e.g., users 12, 14, 16) to select and view content files provided by content providers (e.g., content providers 18, 20), such that one or more advertisements may be inserted into the content file in accordance with an ad insertion file.

The advertisements may be provided by advertisers (e.g., advertisers 40, 42, 44). These advertisers may be companies that manufacture products and/or companies that provide services. Additionally/alternatively, advertisers 40, 42, 44 may be advertising firms that produce advertisements for companies that manufacture products and/or provide services.

Accordingly, advertisers (e.g., advertiser 44) may provide one or more advertisements (e.g., advertisement file 46) for inserting into a content file (e.g., content file 48). Typically, content file 48 and advertisement file 46 are in a streaming video format, such as a Macromedia FLV file format™, Microsoft Windows AVI™ file format, or a Real Networks RAM™ file format, for example. Examples of advertisement file 46 may include thirty-second ads for television shows, vacation resorts, and/or upcoming theatrical releases, for example. Examples of content file 48 may include story-specific news files (e.g., a news report concerning a car accident), sporting events, and/or syndicated shows, for example. Typically, the content files (e.g., content file 48) are stored on one or more content servers (e.g., server 50) maintained by the content provider (e.g., content provider 20).

Once produced by the advertisers, the advertisements (e.g., advertisement file 46 produced by advertiser 44) are hosted either locally (e.g., on a local server 52 maintained by advertiser 44) or remotely (e.g., on an advertisement server 56). Advertisement server 56 may be a third-party server that streams (e.g., to users 12, 14, 16) the advertisements produced by advertisers 40, 42, 44.

Typically, when a content file (e.g., content file 48) is defined and made available on a website maintained by a content provider (e.g., content provider 20), an ad insertion file 54 may be defined for that content file. Ad insertion file 54 may define the specific points within the content file (e.g., content file 48) at which an advertisement (e.g., advertisement file 46) is to be inserted. For example, if content file 48 is twenty minutes long, content provider 20 may wish to insert four thirty-second advertisements within the content file. Therefore, a thirty-second advertisement may be inserted e.g., at time t=0:00 (i.e., at the very beginning of content file 48); at time t=5:00 (i.e., five minutes from the beginning of content file 48); at time t=10:00 (i.e., ten minutes from the beginning of content file 48); and at time t=15:00 (i.e., fifteen minutes from the beginning of content file 48). Accordingly, for content file 48, ad insertion file 54 may specify advertisement insertion points of: 0:00; 5:00; 10:00; and 15:00. While ad insertion file 54 specifies the points at which an advertisement is to be inserted into a content file, it may not specify the specific advertisement to be inserted. As will be discussed below, this decision may be made by advertisement server 56.

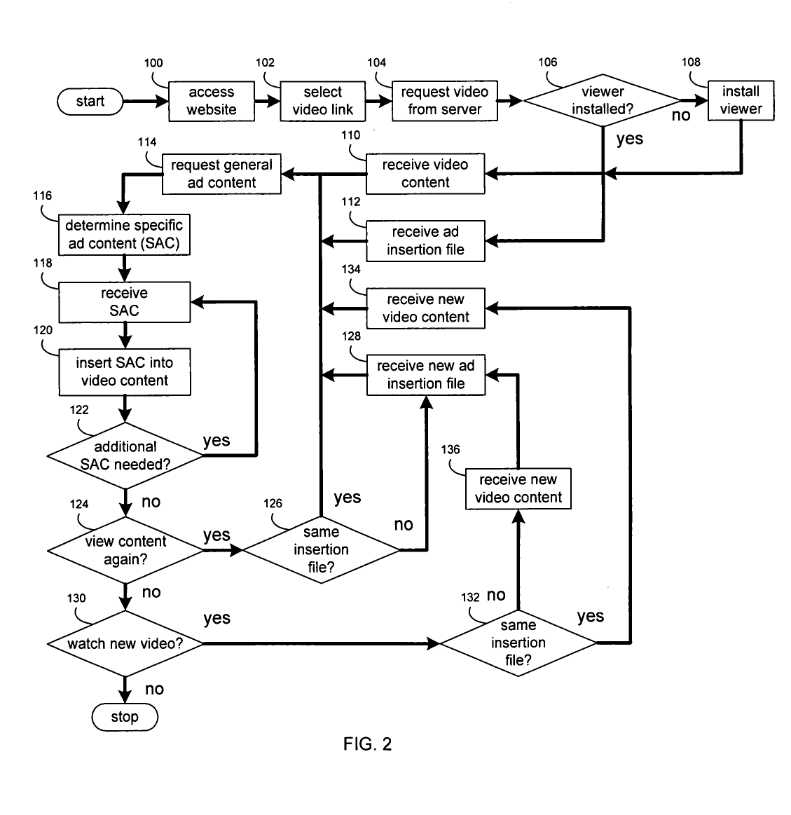

Referring also to FIG. 2 and as discussed above, when viewing content file 48, a user (e.g., user 12) typically visits 100 the website of a content provider. Examples of content provider websites may include www.cnn.com™ and www.foxnews.com™. Assuming that user 12 selects 102 content file 48 for viewing, dynamic advertisement system 10 may be accessed and the appropriate ad insertion file may be requested 104. As discussed above, concerning content file 48, ad insertion file 54 may specify four advertisement insertion points, namely at times: 0:00; 5:00; 10:00; and 15:00.

Dynamic advertisement system 10 may determine 106 whether the user has the appropriate viewer 49 installed and (if not) the appropriate viewer 49 is installed 108 on the computer 30. Examples of typical viewers 48 include Real Networks Real Player™, Microsoft Windows Media Player™, Macromedia Flash Player™, and a custom viewer. Once the appropriate viewer 49 is installed and ad insertion file 54 is accessed, the appropriate files are retrieved. Accordingly, content file 48 (which may be stored on server 50 maintained by content provider 20) may be provided 110 to user 12, and ad insertion file 54 (which may be stored on computer 22) may also be provided 112 to user 12. Once received by user 12, viewer 49 (installed on computer 30 of user 12) may process ad insertion file 54 to determine the number and frequency of advertisements. As discussed above, in this example, the ad insertion file (e.g., ad insertion file 54) associated with content file 48 specifies four advertisements to be inserted at times: 0:00; 5:00; 10:00; and 15:00. Accordingly, viewer 49 may request four advertisements from e.g., advertisement server 56.

Ad insertion file 54 may merely specify the quantity of advertisements, such that the specific advertisements inserted are determined by advertisement server 56. For example, assume that advertisement server 56 is currently serving ten advertisements (e.g., AD01-AD10). Depending on the manner in which advertisement server 56 is configured, the advertisement server may systematically cycle through all ten advertisements prior to repeating the first advertisement. Accordingly, the first time content file 48 is played, advertisements AD01-AD04 may be inserted into content file 48, such that the second time content file 48 is played, advertisements AD05-AD08 may be inserted. Accordingly, the third time that content file 48 is played, advertisements AD09, AD10, AD01 and AD02 may be inserted. This cycling may be configured such that the cycle must be completed by a single user (e.g., user 12) before the cycle is completed. Therefore, user 12 may be required to view advertisements AD01-AD10 before they would see advertisement AD01 again. Alternatively, the cycle may be based on all users, such that user 12 (upon viewing content file 48) may see advertisements AD01-AD04, and user 14 (upon viewing content file 48) may see advertisements AD05-AD08), and user 16 (upon viewing content file 48) may see advertisements AD09, AD10, AD01 and AD02.

These advertising cycles may be further varied such that: advertisement AD01 is always viewed each time content file 48 is viewed; or advertisement AD01 is always viewed each time any content file is viewed, for example.

Accordingly, upon processing ad insertion file 54, viewer 49 may request 114 four advertisements. As discussed above, viewer 49 may generically request advertisements and may not specifically request certain advertisements, as the specific advertisements served may be decided by advertisement server 56. Continuing with the above stated example, once viewer 49 requests 114 the advertisements (i.e., four advertisements in this example), advertisement server 56 may determine 116 the specific advertisement content (SAC) to be provided to viewer 49. Once this determination is made (in accordance with e.g., the advertisement rotation discussed above), the four advertisements (e.g., advertisements 46, 58, 60, 62) may be provided to and received by 118 viewer 49. These four advertisements (e.g., advertisements 46, 58, 60, 62) may then be inserted 120 into content file 48 in accordance with ad insertion file 54. Typically, the sequence of the advertisements is assigned by advertisement server 54 (e.g., AD01 fills the first slot, AD02 fills the second slot, and so on). However, it is foreseeable that the sequence may be assigned by viewer 49.

A verification 122 may be made to ensure that all the required advertisements were received. If not, additional advertisements may be received 118 and inserted 120. Once all the advertisements are received 118 and inserted 120 into content file 48, user 12 may view content file 48 and advertisements (e.g., advertisements 46, 58, 60, 62) using viewer 49. Once completed, user 12 may decide 124 to watch content file 48 again. If user 12 decides to watch content file 48 again, the same ad insertion file may be used again, or a new ad insertion file may be processed.

If it is determined 126 that the same ad insertion file is to be used again, viewer 49 may generically requests 114 four advertisements, and advertisement server 56 may determine 116 the specific advertisement content (SAC) to be provided to viewer 49. Alternatively, if it is determined 126 that a new ad insertion file is to be processed, the new ad insertion file may be received 128 by viewer 49. Assuming that the new ad insertion file specifies three advertisement insertion points (e.g., at times: t=0:00; t=10:00; and t=20:00), viewer 49 may generically request 114 three advertisements, and advertisement server 56 may determine 116 the specific advertisement content (SAC) to be provided to viewer 49.

Once user 12 has completed viewing content file 48, user 12 may decide 130 to view a different content file (e.g., content file 64). If content file 64 is reasonably similar to content file 48, the same ad insertion file may be used for content file 64. For example, if content files 48, 64 are both twenty minutes news broadcasts, it may be possible to use the same ad insertion file (i.e., ad insertion file 54) for multiple content files (i.e., content files 48, 64). Accordingly, if it is determined 132 that the same ad insertion file (e.g., ad insertion file 54 which specifies four advertisement insertion points) is to be used for new content file 64, the new content file (i.e., content file 64) may be received 134 by viewer 49, viewer 49 may generically request 114 four advertisements, and advertisement server 56 may determine 116 the specific advertisement content (SAC) to be provided to viewer 49.

Alternatively, if it is determined 132 that a new ad insertion file (e.g., an ad insertion file that specifies only three advertisement insertion points) is to be processed, new content file (i.e., content file 64) may be received 136 by viewer 49, and the new ad insertion file may also be received 128 by viewer 49. Viewer 49 may then generically request 114 three advertisements, and advertisement server 56 may determine 116 the specific advertisement content (SAC) to be provided to viewer 49.

While the ad insertion file is described above as only specifying the advertisement insertion points throughout the content file, other configurations are possible. For example, the ad insertion file may be configured to not only specify the advertisement insertion points but also the specific advertisements to be inserted. Accordingly, when processing the ad insertion file and requesting advertisements from e.g., advertisement server 56, requests may be made for specific advertisements (as opposed to generic requests for e.g., three advertisements).

While advertisements are described above as being uploaded to advertisement server 56, other configurations are possible. For example, advertisements may be stored on and streamed from servers (e.g., server 52) maintained by advertisers 40, 42, 44.

While content files 48, 64 are described above as being video-based files, other configurations are possible. For example, content files 48, 64 may be text-based files that are read by e.g., user 12. Accordingly, prior to being able to read a first portion of content file 48, a user may be required to view e.g., advertisement 46. Once advertisement 46 is viewed, the user may be provided with a second portion of content file 48. Once read, the user may be required to view e.g., advertisement 58 prior to being able to read a third portion of content file 48.

While advertisements 46, 58, 60, 62 are described above as being video-based advertisements, other configurations are possible. For example, one or more of advertisements 46, 58, 60, 62 may be static (i.e., non-video) advertisements.

A number of implementations have been described. Nevertheless, it will be understood that various modifications may be made. Accordingly, other implementations are within the scope of the following claims.

What is claimed is:

1. A dynamic advertisement method comprising:
receiving a request for a content file from a user;
processing an ad insertion file associated with the content file, wherein the ad insertion file associates one or more advertisements with the content file; and
facilitating the insertion of the one or more advertisements into the content file.

2. The method of claim 1 wherein the content file is a video data stream.

3. The method of claim 1 wherein facilitating the insertion of the one or more advertisements includes:
obtaining the one or more advertisements from a remote server.

4. The method of claim 1 wherein facilitating the insertion of the one or more advertisements includes:
requesting the one or more advertisements from a remote server.

5. The method of claim 1 wherein facilitating the insertion of the one or more advertisements includes:
inserting the one or more advertisements into the content file.

6. The method of claim 1 further comprising:
verifying that the user has a content viewer installed that is capable of viewing the content file.

7. The method of claim 6 further comprising:
installing the content viewer if the user does not have a content viewer installed that is capable of viewing the content file.

8. The method of claim 1 further comprising:
associating the ad insertion file with multiple content files.

9. The method of claim 1 further comprising:
transmitting the content file to the user.

10. The method of claim 1 further comprising:
transmitting the one or more advertisements to the user.

11. A system configured to perform the method of claim 1.

12. A computer program product residing on a computer readable medium having a plurality of instructions stored thereon which, when executed by the processor, cause that processor to perform operations comprising:
receiving a request for a content file from a user;
processing an ad insertion file associated with the content file, wherein the ad insertion file associates one or more advertisements with the content file; and
facilitating the insertion of the one or more advertisements into the content file.

13. The computer program product of claim 12 wherein the content file is a video data stream.

14. The computer program product of claim 12 wherein the instructions for facilitating the insertion of the one or more advertisements include instructions for:
obtaining the one or more advertisements from a remote server.

15. The computer program product of claim 12 wherein the instructions for facilitating the insertion of the one or more advertisements include instructions for:
requesting the one or more advertisements from a remote server.

16. The computer program product of claim 12 wherein the instructions for facilitating the insertion of the one or more advertisements include instructions for:
inserting the one or more advertisements into the content file.

17. The computer program product of claim 12 further comprising instructions for:
verifying that the user has a content viewer installed that is capable of viewing the content file.

18. The computer program product of claim 17 further comprising instructions for:
installing the content viewer if the user does not have a content viewer installed that is capable of viewing the content file.

19. The computer program product of claim 12 further comprising instructions for:
associating the ad insertion file with multiple content files.

20. The computer program product of claim 12 further comprising instructions for:
transmitting the content file to the user

21. The computer program product of claim 12 further comprising instructions for:
transmitting the one or more advertisements to the user.
